(19) United States
(12) Patent Application Publication
(10) Pub. No.: US 2020/0034766 A1
(43) Pub. Date: Jan. 30, 2020

(54) SYSTEM AND METHOD TO INCREASE PRODUCTIVITY

(71) Applicant: Gabriel Borges, Sao Paulo (BR)

(72) Inventor: Gabriel Borges, Sao Paulo (BR)

(21) Appl. No.: 16/047,310

(22) Filed: Jul. 27, 2018

(51) Int. Cl. G06Q 10/06; G06Q 30/08

(52) U.S. Cl. CPC G06Q 10/06313; G06Q 30/08

(57) ABSTRACT

A system for construction project resource management including a plurality of interactive modules that track construction resources and determine construction compliance with construction plans. One of the plurality of interactive modules is a tracking module configured to physically track assets, materials, equipment and labour. One of said plurality of interactive modules is a compliance module configured to comparing actual construction data with project plan specifications. The compliance module may be further configured to receive actual construction data from the tracking module and may be further configured to transmit the compared data to a user. Another one of said plurality of interactive modules is a smart contract module configured to receive an order request, process the received order request into a project bid, and process the project bid to secure a success bid for the received order request.

### REFERENCE TO PENDING APPLICATIONS

This application does not claim the benefit of any issued U.S. Patent or pending application.

### BACKGROUND OF THE INVENTION

### Field of the Invention

The present application relates to the general field of resource management, and in particular to a system and method of increasing productivity and efficiency of resource management.

### Background

In many industries, such as the construction industry, inefficiency is common place. This inefficiency increases the cost and completion time of a project, which can lead to investors to not invest any additional resources into the project.

This inefficiency is based on a number of factors including the management of resources such as assets materials and labor. Additionally, this inefficiency is due to low technological levels.

Thus, there is a need for technological based improvement to the management of resources to increase productivity and reduce inefficiency.

BRIEF SUMMARY OF THE INVENTION

The inventive concept is generally directed toward resource management, and in particular to a system and method of increasing productivity and efficiency of resource management.

In one aspect of the present invention, a system for construction project resource management is disclosed. This system includes a plurality of interactive modules that track construction resources and determine construction compliance with construction plans and project models. One of said plurality of interactive modules is a tracking module configured to physically track assets, materials, equipment and labour. Another one of said plurality of interactive modules is a compliance module configured to comparing actual construction data with project plan and model specifications.

In some aspects, the compliance module is further configured to receive actual construction data from the tracking module and is further configured to transmit the compared data to a user.

In some aspects, one of said plurality of interactive modules is a smart contract module configured to receive an order request, process the received order request into a project bid, and process the project bid to secure a success bid for the received order request.

### BRIEF DESCRIPTION OF THE DRAWINGS

In drawings which illustrate embodiments of the invention wherein similar characters of reference denote corresponding parts in each view,

FIG. 1 is a schematic flowchart of an embodiment of the present invention.

FIG. 2 is a schematic flowchart of an embodiment of the tracking module of the present invention.

FIG. 3 is a schematic flowchart of an embodiment of the tracking module of the present invention.

FIG. 4 is a flowchart of an embodiment of the tracking module in operation according to embodiment of the present invention.

FIG. 5 is a flowchart of an additional embodiment of the compliance module according to embodiment of the present invention.

FIG. 6 is a flowchart of an additional embodiment of the compliance module in operation according to embodiment of the present invention.

FIG. 7 is a flowchart of an additional embodiment of the compliance module in operation according to embodiment of the present invention.

FIG. 8 is a flowchart of an additional embodiment of the compliance module in operation according to embodiment of the present invention.

FIG. 9 is a schematic flowchart of an embodiment of the smart contract module of the present invention.

### DETAILED DESCRIPTION OF THE INVENTION

In general, the present invention is directed toward a system method to increase productivity. Embodiments of the present invention include components to physically track assets materials and labour, digital tracking of resources, and compliance.

Embodiments of the inventive system and method have at least two modules that utilized construction related data in an interactive manner in order to increase productivity. These modules may include a tracking module, a compliance module and a smart contract module. Those skilled in the art will recognize that these modules are illustrative and is not limiting.

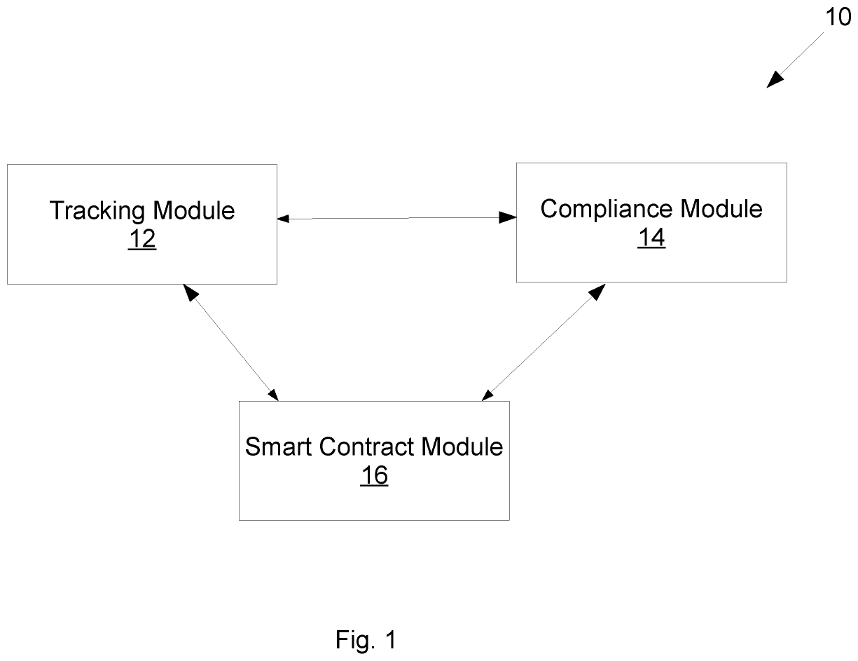

As illustrated in FIG. 1, one embodiment of the inventive system 10 may have at least three modules that utilize construction related data in an interactive manner in order to increase productivity. These modules may be a tracking module 12, a compliance module 14 and a smart contract module 16 directed toward the tracking of resources, evaluation of compliance and/or creation of smart contracts.

The tracking module 12 is generally directed toward the tracking of resources utilized during a construction project. These resources can include materials and labour.

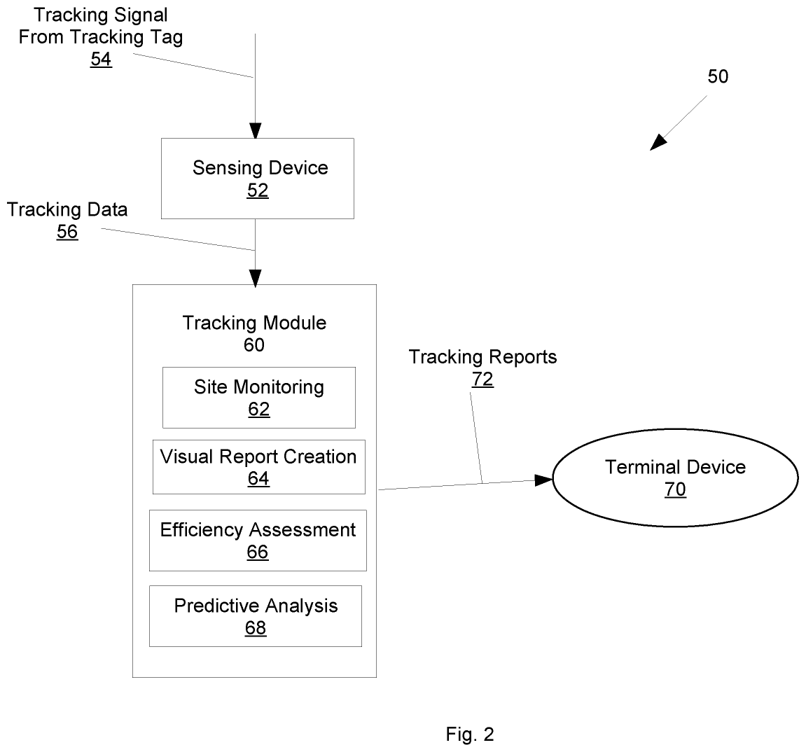

As illustrated in FIG. 2, in one embodiment, tracking module 60 receives tracking data 56 from a sensing device 52 that receives tracking signals 54 from tracking tags that are associated with materials, workers and assets which may be attached thereto. The tracking tag may include Bluetooth low energy (BLE), radiofrequency identification (RFID), barcode, QR code or other sensing tags that may send a signal to a sensor for detection. In one embodiment, a sensing tag may be capable of sending BLE and RFID signals simultaneously and may be received by sensing equipment that can also be read by BLE and RFID signals simultaneously.

Additionally, an embodiment of the tracking module may utilize GPS to track equipment that moves from various construction sites as well as materials that are being transported over a long distance. For example, in the mining industry when trucks are utilized over light distance a GPS may be utilized to monitor and track the location of each of the trucks on the construction site. For example, GPS tracking can be used to track the transportation of materials in large construction sites, or outside of them as well as to monitor the use aspects and position of specialized equipment (movement patterns, time of use and location of a bulldozer, for example)

Tracking module 60 has components to perform multiple functions with the received tracking data 56. Examples of these functions include activity monitoring of a site 62, the creation of visual reports 64, efficiency assessments 66 and predictive analysis 68 on the tracking data 56. Tracking module 60 includes hardware and software to transmit 72 one or more reports based on the tracking data and the various functions applied thereto to a terminal device 70. This terminal device 70 may be any device capable of receiving such reports, including a laptop computer, tablet computer and smart phone.

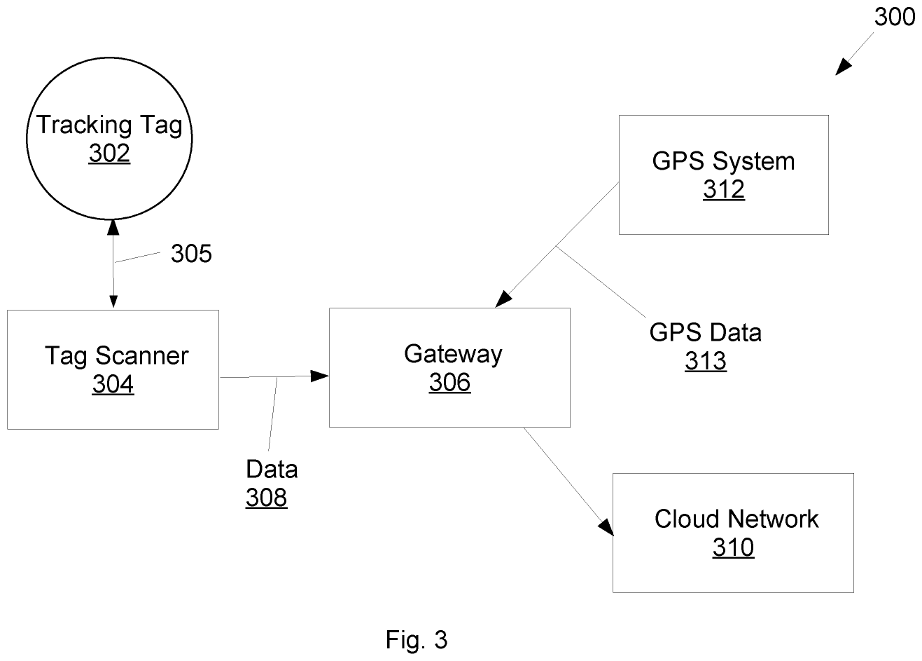

As shown in FIG. 3, an embodiment of the tracking module 300 is illustrated. Tracking module 300 includes a tracking tag 302 that is in bidirectional communication 305 with sensing equipment, referred to as tag scanner 304. Tracking tag 302 is capable of sending BLE and RFID signal simultaneously. Tag scanner 304 is referred to as a scanner and is capable of receiving BLE and RFID signals simultaneously. The received BLE and RFID signals are referred to as scanner data 308.

In this embodiment, tag scanner 304 may be in communication over a communication network with a gateway device 306. Scanner 304 is capable of transmitting, and gateway device 306 is capable of receiving, scanner data 308. Gateway device 306 is also in communication with a GPS system 312 over a communication network where GPS information 313 relating to item tracking information be transmitted to gateway device 306. Gateway device 306 is also in communication with a cloud network 310 and is capable of transmitting scanner data 308 to the cloud network 310. Once scanner data 308 has been transmitted to cloud network 310, scanner data 308 may be further accessed and analyzed therein.

Tag scanner 304 may be any type of sensing equipment that is capable of receiving and transmitting sensing tag tracker data. Gateway device 306 may be a computer processor or other device that is capable of receiving and transmitting data scanner data.

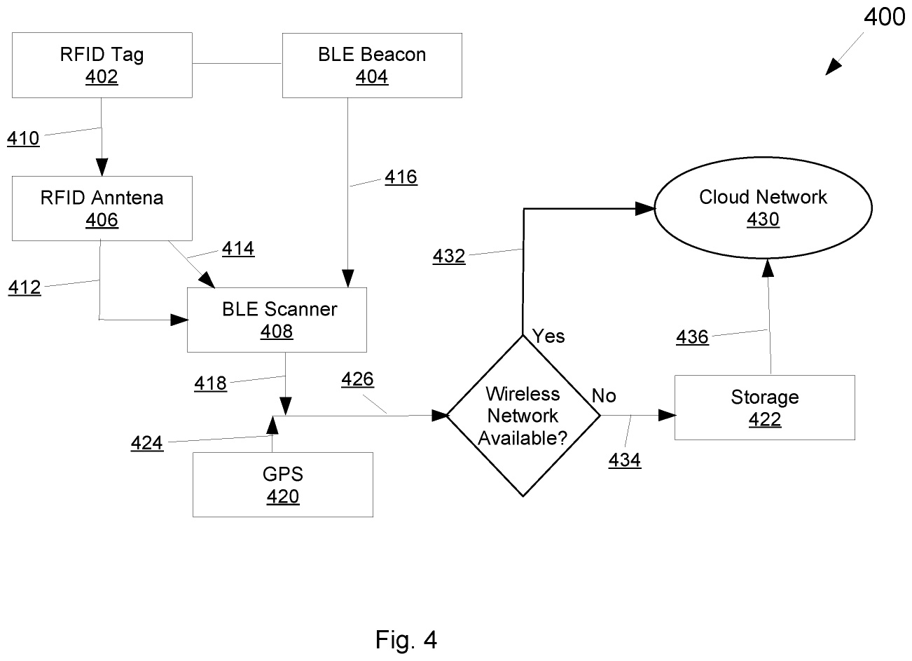

As shown in FIG. 4, an additional embodiment of the tracking module 400 is illustrated. In this embodiment, a gateway device in not included. In this embodiment, a RFID tracking tag 402 and/or a BLE beacon 404 sends a RFID signal 412 or BLE signal 414 respectively to a BLE scanner 408. Regarding the RFID signal 412, in this embodiment, it is first provided to a RFID antenna 406 prior to being transmitted to BLE scanner 408. Further, it may be sent directly in a serial communication configuration 414 or it may be converted to a BLE signal 412.

The BLE scanner 408 transmits 418 the received data to a cloud network 430 for processing. In this embodiment, if a wireless network is available, the data will be sent directly to the cloud server 430. If, however, a wireless network is not available, the data will be kept in a storage 422 until a wireless network is available, at which time the data will be transmitted to the cloud network 430. Additionally, a GPS signal 424 can be transmitted to the cloud network 430.

Regarding the collection of RFID data, those skilled in the art will recognize that various collection methods may be utilized. For example, a first method is to connect a RFID antenna to a BLE scanner via a “serial protocol”. While a second method is the direct translation of RFID radio frequency signal, received by the antenna, to BLE signal.

In this embodiment, regardless of the collection method, the RFID read data goes through the BLE scanner to be transmitted. The advantage of such system is that depending on cost, material type, material shape, sensor position, functionality and workforce acceptance, one radio-frequency technology can be preferred over the other.

In some embodiments, the tracking module may utilize a BLE collector scanner. The scanner may transmit the collected data at the time of collection over a wireless network to a cloud server, or during a predetermined time schedule that can be programmed to account for network traffic to ensure a strong wireless signal availability.

In some embodiments, a smart tag may be utilized. This smart tag may function in connection to a GPS device and may be configured to efficiently utilized the GPS device's battery. The smart tag would, depend on receiving an RFID signal from an antenna to start working. Whenever the GPS tracker gets close and to an RFID transmitting antenna, the GPS tracker enters hibernation and the smart tag assumes the GPS tracker's function, i.e. re-sending signals to the antenna, which is enough to identify the GPS tracker position without consuming battery from the GPS device.

In some embodiments, LoRa nodes are utilized and have the same function as RFID tags. The use of LoRa nodes would allow for three different modes of tracking by the tracking module, e.g. one close to the construction (using RFID), a second close to urban areas (using LoRa), and a third for more isolated areas, using the GPS tracker.

In some embodiments, the tracking data may be provided in a raw state or in one or more comprehensible reports that provide clear and very useful information to the user.

The tracking data may include various kinds of information which can be generated by the sensing data collected by the tracking module. Examples of this data include: graphic visualizations on 2D plans and 3D BIM models; materials analytics; date of arrival; location; movement route; consumption rate; various warehouse metrics; workforce analytics; position; work zone; worker attendance; assets analytics; use time/idle time; movement route; combined analytics; productivity (material consumption/man-hour of work); construction progression (material path vs site areas); and theft mitigation (material path vs personnel around it).

In some embodiments, the tracking module may provide gathered information with third party networks and related software. This information may be in form of predictive analysis of the gather information, such as:

Budget adjustment: depending on construction progression, schedule compliance and external conditions, it may become clear that previous budget previsions will not be fulfilled and some factor for new prevision can be estimated from the software;

Suggestion of purchase orders: knowing the consumption rate of materials and their expected use, it is possible to suggest new purchases that would avoid delays. Similar indications can also work for equipment and workforce numbers;

Efficiency related recommendations: The software will be able to highlight inefficiencies of planning, labour productivity and equipment usage; and

Site layout modifications: Knowing a project phase and based on previous data it is possible to suggest site adaptations aimed at increasing efficiency and productivity while reducing costs.

Regarding the compliance module 14, this module is directed toward comparing what has already been built with the project specifications while documenting this process.

The compliance module is directed toward a bidirectional flow of information from the actual project to the project specifications. In one embodiment the project specifications are created by the Building Information Modelling (BIM) design methodology. The use of the BIM methodology is illustrative and is not meant to be limiting. Those skilled in the art will recognize that other design methodologies are within the scope of the present invention.

The BIM design methodology models the construction project by rendering a 3D model of the project and linking various design information and resource management aspects to the various components of the project. The BIM project information is stored on a computer network such as a cloud server or local company computer network. For example, a BIM model of a construction project may include product specifications for specific electrical components and the scheduled date for delivery of those components to the construction site.

In this aspect, embodiments of the compliance model interact with the BIM model information to ensure compliance. This embodiment utilizes a bidirectional flow of information from between the compliance module and the BIM model software.

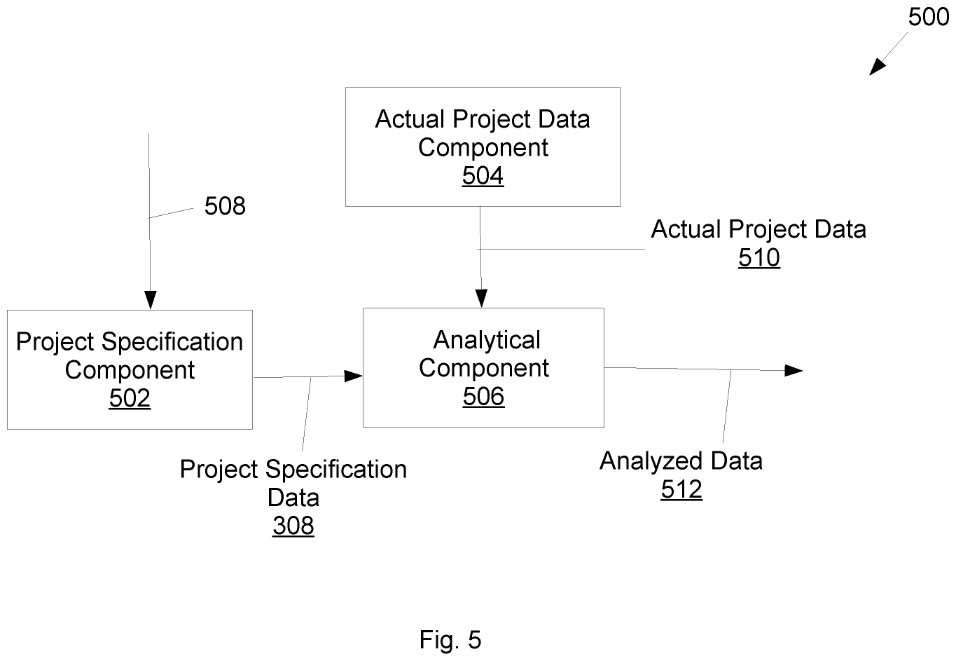

As shown in FIG. 5, an embodiment of the compliance module 500 is illustrated. Compliance module 500 includes a project specification component 502, actual project data component 504, and analytical component 506. The analytical component 506 is in communication with both the project specification component 502 and the actual project data component 504.

The project specification component 502 is capable of receiving and/or creating project specification data 508 and transmitting the project specification data 508 to analytical component 506. Project specification data 508 may be any type of data specified for a project including materials, labour, assets, schedules of delivery, and schedules of completion.

Actual project data component 504 is capable of receiving actual project data 510 and transmitting the actual project at a 510 to analytical component 506. Actual project data 510 may be any type of data related to the actual construction of the project. This data may include any type of data relating to the actual construction of the project, including but not limited to, any resources tracked by tracking module 12. Actual data project component 504 may receive or create actual data project data 510.

Analytical component 506 is capable of receiving and analyzing project specification data 508 and actual project data 510. Analytical component 506 is configured to compare the received data and to determine if the actual project at a 510 is in compliance with the project specification data 508. Further analytical component 506 is capable of transmitting the analyzed data 512 to a user device, such as a computer a tablet or a smartphone.

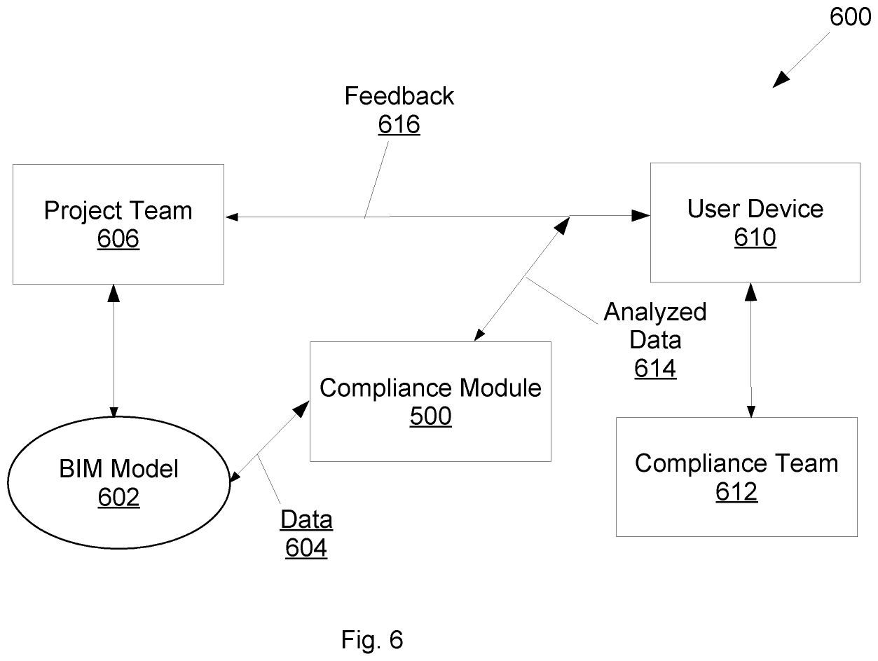

As illustrated in FIG. 6, an embodiment of the environment 600 of compliance module 500 is shown. In environment 600, compliance module 500 is in communication with a BIM model component 602. BIM model component 602 provides the project's specification data 604 to compliance module 500. The project specification data 604 is created by a project team 606 which is in communication with BIM model component 602.

Compliance module 500 is also in communication with a compliance user device 610 which is utilized by a compliance team 612. Compliance team 612 reviews the analyzed data 614 received from compliance module 500 for compliance with the project specification data 604.

Compliance user device 610 is also configured for access by project team 606 so that project team 606 may receive feedback 616 from compliance team 612. This feedback may include issues events or concerns regarding compliance or modification of the original product specification data 604.

An example of the compliance module 500 is as follow. This example involves a construction project utilizing the Building Information Modeling (BIM) design methodology. The BIM model of the subject project is generated by the project team with commercial BIM software. The BIM model will contain data relating to specific details of the construction project including specific details regarding materials and labour. The resulting project file is created in Industry Foundation Classes (IFC) format. This format is an open standard for BIM files, created to solve compatibility issues with different BIM software. The use of the IFC format is illustrative and is not meant to be limiting. Those skilled in the art will recognize that other formats may be utilized and are within the scope of the present invention.

The IFC file is provided to the compliance module where the specific project data in the IFC file is compared and analyzed to actual project data. The analyzed data can be provided to a user device, such as a tablet or smart phone, where it can be reviewed by the compliance verification team.

If the compliance team determines that an issue with the project's time schedule or materials, the IFC file can be modified to highlight the issue. This enables the issue to be seen in context within the BIM software.

The reviewed IFC file may be provided to the project team to review to determine if the issue may impact in planning.

The compliance module and a storage device may be located within a cloud network so that the project data may be accessible from multiple locations.

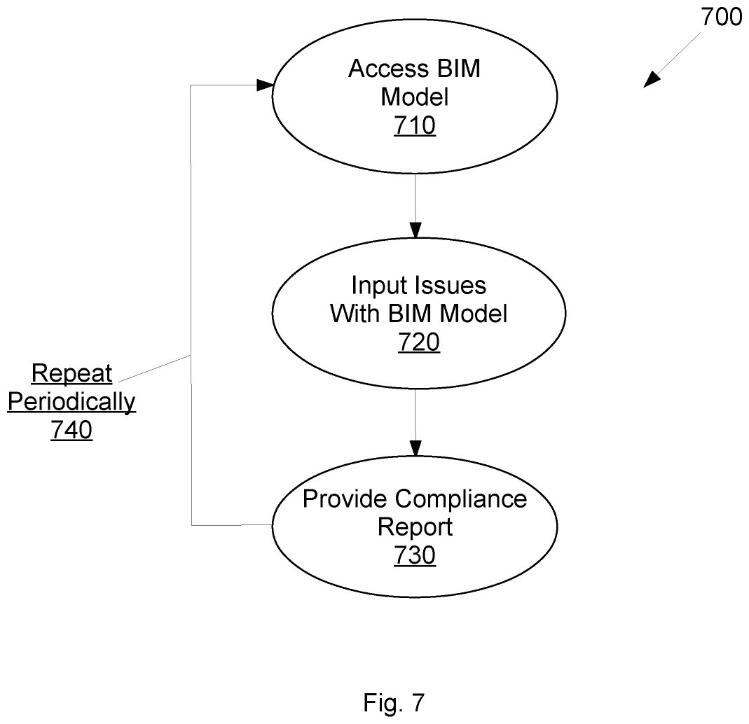

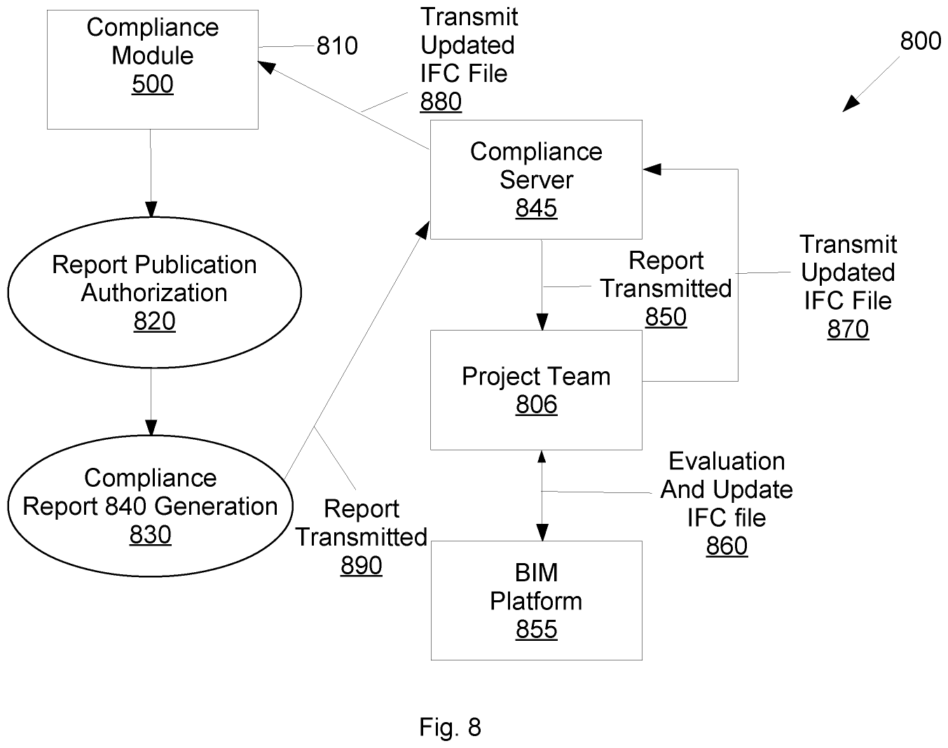

An embodiment of the operation of compliance module 500 is illustrated in FIGS. 7-8. In this embodiment, as illustrated in FIG. 7, BIM model 602 are accessed by a user 710, the user may then input compliance issues with the compliance module 720. The compliance module 500 provides a compliance report 730 to the project team 606. The operation may then repeat 740 as compliance issues are determined by the user.

As illustrated in FIG. 8, an embodiment of the data flow 800 through the operation of compliance module 500 is shown. In this embodiment, compliance module is accessed 810 by a user. In this embodiment, compliance module may be located with a client device, such as a laptop computer, tablet computer, smart phone or other portable device. Further, the compliance module may be a stand-alone software application or located within software application having multiple functions. The user authorizes the publication of a compliance report 820. The compliance module will generate 830 a compliance IFC based report 840. The IFC based report 840 is merely illustrative. Those skilled in the art will recognize that the report may be in various formats, including but not limited to, IFC, BCF and simple text.

The compliance report 840 is transmitted 890 to a compliance server 845 where it will be transmitted to the project team 606. The compliance server 845 may be located within one or more of any type of computer network, including a LAN, WAN, internet or cloud server systems.

The project team 606 may be able to evaluate the compliance report 840 and be able to take actions to address any non-compliant aspects of the project specifications as set out in the project's IFC file. These actions will result in an updated IFC file 860. The evaluation of the compliance report 820 and the updating of the IFC file may be performed by the use of the project team's BIM software platform 855. The BIM software platform 855 may be located within any type of computer system. The project team 606 then transmits 870 the updated IFC file to the compliance server 845, where it may be then transmitted 880 to the compliance module 500. The user may then implement the updated IFC file at the project site.

Regarding the compliance reports, they may be multiple formats of compliance reports. A first format is a text or multimedia report, a second format uses the IFC file format, while a third type uses the BIM Collaboration Format (BCF) files. The latter format was also created by buildingSMART and is the preferred way of sharing and communicating BIM data. Both the IFC and the BCF procedures would fit into an open BIM workflow.

In some embodiments, a 3D BIM tool for visualization may be utilized within the compliance module 500. These embodiments may allow a user to select specific elements with issues and create reports that refer specifically to them.

In some embodiments, a 4D BIM tool, which includes schedule and possibly cost information about the project. These embodiments may allow the exporting of schedule data in a format that can be interpreted by other software.

Examples of the compliance module may include:

Important equipment in a building can have their functioning checked. Any issues found are going to be addressed to the specific component which should be represented in the model design. This will be sent to the responsible team, with the model representation of the equipment possibly containing already the necessary specification for repair or replacement scenarios.

While checking a floor's already concreted structure, it was found that some beams had smaller dimensions than specified in project. As it is possibly a case for concern, a high priority report is going to be sent to the structural designer, who will evaluate if the condition can be kept like that or if a structural reinforcement is necessary. Both ways, this documentation is an invaluable piece of data and of great interest for further analysis, to attribute responsibilities or correct flawed practices.

Plumbing work can be verified in a great level of detail. From the 3D model it is possible to see and check from BIM data (height, angle, diameter, etc.) that a pipe is located at a different position or with a different slope than specified, which may not pose an actual problem to its functioning. The report can be sent describing the problem and attaching pictures showing the situation. That may or may not call a repair order, but either way the BIM model cam now be easily modified to “as-built”.

An HVAC system is to be installed in the building and the foreman checks via the app if the components in the project are available on site. The person finds that some of those elements are missing and then sends a high-priority report indicating the exact specification, position and number of missing elements.

It is possible to include information about earthwork progress in the report, from where it can be calculated (roughly) and documented the percentage of completion of a work phase. This can also be used to fraction payments to the sub-contractors doing the work.

Various statistical analysis can be performed, involving rate, type, location, discipline and other factors relating to the issues identified. This can give important indication about results below expectation, broken processes and incorrect project choices.

After a time using the software, the statistical analysis of the compliance results could easily be used to predict rates and types of issues for next construction phases and even new construction developments with similar features.

The generated compliance reports may be stored. With an adequate data processing and purpose specific algorithms, such as machine learning applications, it will be possible to provide a predictive analysis service on compliance issues. It will provide personalized assessment in terms of type of construction, size, region, as well as more detailed project decisions such as the structural system adopted.

Regarding the smart contract module 16, this module is directed toward the creation of project specific contracts based on project specific data.

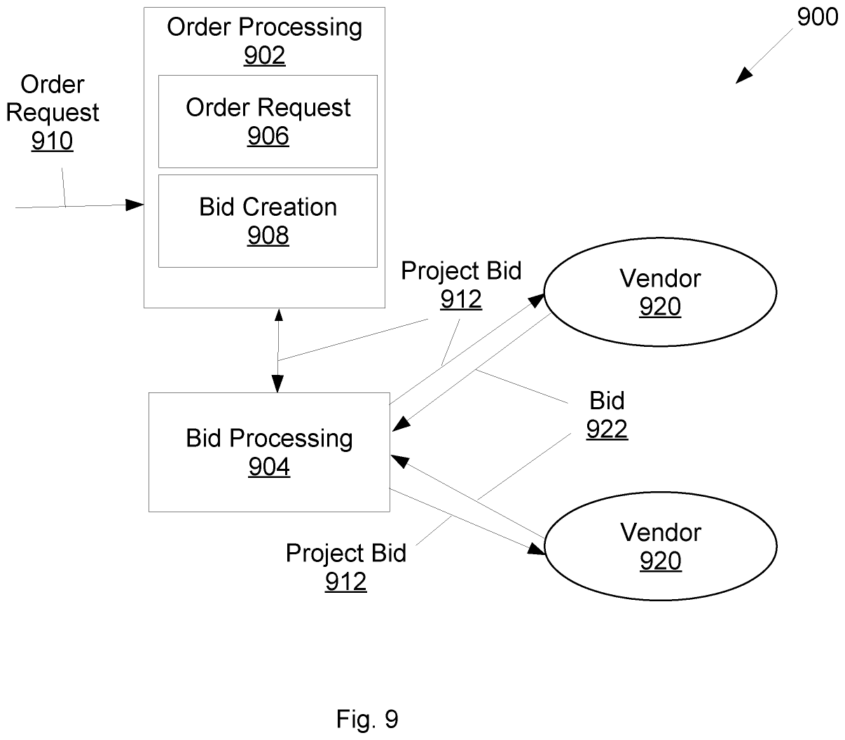

As shown in FIG. 9, an embodiment of smart contract module 900 is illustrated. Smart contract module 900 includes an order processing component 902 and a bid processing component 904 that is in communication with order processing component 902. Order processing component 902 includes an order request subcomponent 906 and a bid creation subcomponent 908.

Order request subcomponent 906 is configured to receive a bid request 910 from an outside source via any communication network. This outside source may be an embodiment of compliance module 14. Once received, bid creation subcomponent 908 creates a project bid 912 based on bid request 910. Order processing component 902 then provides project bid 912 to bid processing component 904.

Once bid processing component 904 receives project bid 912 from order processing component 902, bid processing component 904 is configured to provide the project bid 912 to one or more vendors 920, and receive bids 922 from the vendors 920. The received bids 922 are analyzed by bid processing component 904 to determine which bid will be accepted. This determination may be based on multiple factors including but not limited to cost, quality, proximity and other relevant parameters. Bid processing component 904 is also configured to notify the vendor 920 that submitted the selected bid 922.

In an embodiment, smart contract module 900 may be configured to create documents relevant to the ordering and delivery of the subject matter of the specific bids. These documents may be purchase order, delivery contracts and other similar type of documents. Further, these documents may be executed digitally or may be downloaded for execution.

The inventive system and method provides advantages for resource management.

Regarding materials, it is possible to know where the materials are located and what is their path of movement. It can thus be used to track the progress of a construction project. For example, material X is only used in Y phase of construction and it is being directed to area Z of the construction site, which attests the start of phase Y.

Further, when a material lot arrives at the construction site, it may be redirected to a storage location, such as a warehouse, where it can be tagged for tracking. The information relating to this material lot may be automatically updated to the system, providing another verification for the delivery.

The system assists the work of a construction manager. The system allows for multiple pieces of material data that is stored in a storage location, e.g. warehouse stocks, such as the amount of certain materials, rate of withdrawal, last time it was withdrawn and expected shortages.

This allows for easier management of the distribution of materials throughout various working faces according to need. For example, if having a certain material in-stock is critical for the progress of the construction, the system can ensure it is resupplied in time; material routes can be tracked and analyzed in terms of efficiency regarding distance, overcrowding and means of transportation. Further, if high cost materials disappear from the stock the system can detect what was the last time it was found in stock and who was near the area at the time. Knowing that the materials and people can be tracked, the equipment prevents and discourages theft.

Regarding the management of the workforce, the inventive system and method may separately identify individual teams enabling more specific assessments; may verify attendance and legal conditions of each worker, indicating any situation of concern; may interactively and remotely see the workforce routes and perform similar analysis to that of material routes and may indicate the location in real time of each worker in the construction site.

From that, the inventive system and method may conduct several analyses in terms of knowing where the working faces are, where are the workers placed in relation to it and what each team is doing. This analysis may include permission verification by actively determining if a worker is located in a construction zone that is dangerous and/or that is otherwise restricted.

The inventive system and method may also provide combined materials/workforce analysis. This analysis may include a productivity measurement based on a “rate of material use”/“number of workers per team” ratio. Further, a construction site may be divided in “working zones” which are graphically portrayed to the user over construction plans and 3D models. This facilitates the understanding of reports, involving workers/materials location, from past dates or in real time. Further, the 3D visualization with BIM can also be used to show material/workers routes graphically to the user.

Regarding equipment, the inventive system and method may monitor all equipment in terms of its use time, movement patterns and location. With this information a company can evaluate the efficiency of their current strategy, say, by realizing, based on the data, that withdrawing a few bulldozers from the fleet won't have a great impact on overall productivity. Further, equipment theft is prevented and discouraged because of the outdoor tracking equipment. Additionally, safety zones can be created around dangerous equipment, accusing when an unauthorized worker enters the area.

Regarding compliance with the project specifications, created by BIM modeling or any other construction modeling plan, the inventive system and method may notify a project team when a structural error is discovered, either by the inventive system or through manual input by a user. This aids a construction evaluator, as the evaluator does not lose construction data only because it can be corrected by the site team. Further, the inventive system and method can duly document this process. Automated reports may be created that contain specific information about a type of elements, material, labour, etc. By having the actual project progress tied to the project specifications, a 3D model may be created that demonstrates a visual representation of the construction progress

In additional embodiments, another module is directed toward the of optimizing projects. This module may provide suggested active feedback on project decisions, showing what are the predicted outcomes in terms of cost, ease of construction, accessibility, probability of issues, etc. This module may permit the user to program personalized checks in a flexible programming platform, which can be used to verify regulatory compliance of the design.

This module may work with any commercially available BIM authoring tool, fed by specifications from machine learning algorithms responsible for interpreting the data collected from prior projects in conjunction with known industry good practices. Besides predictive analysis, this module may also provide the verification of good industry practices and the possibility to implement regulatory compliance checks. Together with the bid system, a smart contract system that registers the contractual agreement and self-executes the financial transactions when there is multilateral agreement can be implemented. This functionality can also operate independently from the bidding.

Examples of embodiments of the various modules include:

Company 1 is a large contractor company, being at one of the edges of the construction industry chain. Company 2, a cement plant, represents those that supply products or provide services directly to the constructions. Company 3, a limestone quarry, represents those companies at the base of the industry supply chain.

There are two types of cement involved in this example, one for general use while other is for foundations. The cement sacks are to be delivered at different stages of construction, each being a separate transaction. When a transaction is done, all parties agree on its completion and the financial payment is executed.

Depending on the smart contracts development platform, the “cement purchase” section, and each transaction within it could be considered a separate smart contract. Smart contracts can automatically generate other smart contracts. With it, it is possible to create intricate applications, that may include blockchain applications, that fulfill all finance related needs of companies from the sector.

In the example, assume a transaction of cement type 1 was not delivered on time according to one verifiable contract clause. Another route of contracts would then be activated, where this transaction is first to be dealt with, while other transactions depend on its completion. These other subsequent transactions may also be manually activated.

The intention is to extend this transaction model to the whole supply chain, in this case, up to the stone quarry (Company 3). This can be combined with a construction specific crypto coin, used by the smart contract transactions. The company ranking system will be based on data that comes directly out of the smart contracts' specification, which may include BIM data or tracking data. The ranking will not only consider price, but it will focus on characteristics such as schedule compliance, reliability, speed and other relevant issues.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A system for construction project resource management comprising:
a plurality of interactive modules that track construction resources and determine construction compliance with construction plans.

2. The system of claim 1, wherein:
one of said plurality of interactive modules is a tracking module configured to physically track assets, materials, equipment and labour.

3. The system of claim 1, wherein:
one of said plurality of interactive modules is a compliance module configured to comparing actual construction data with project plan specifications.

4. The system of claim 3, wherein the compliance module is further configured to receive actual construction data from the tracking module.

5. The system of claim 4, wherein the compliance module is further configured to transmit the compared data to a user.

6. The system of claim 1, wherein:
one of said plurality of interactive modules is a smart contract module configured to receive an order request, process the received order request into a project bid, and process the project bid to secure a success bid for the received order request.
